(19) United States
(12) Patent Application Publication
(10) Pub. No.: US 2008/0042112 A1
(43) Pub. Date: Feb. 21, 2008

(54) Fireproofing Agent

(76) Inventor: Manfred Petermuller, Georgensgmund (DE)

Correspondence Address: Robert L. Epstein;Epstein Drangel Bazerman & James, 60 East 42nd Street, Suite 820, New York, NY, 10165, US

(21) Appl. No.: 11/795,929

(22) PCT Filed: Jan. 20, 2006
(86) PCT No.: PCT/EP06/00512

§ 371 Date: Jul. 23, 2007

(30) Foreign Application Priority Data
Jan. 21, 2005 (DE) 10 2005 003 167.6

(51) Int. Cl. C09K 21/04

(52) U.S. Cl. 252/610; 252/601

(57) ABSTRACT

A flame retardant serves to reduce the risk of fire posed by an ignitable substance. The flame retardant comprises at least one carbon donor and one phosphorus-containing acid. In the event of fire, this flame retardant forms fullerenes, which protect the ignitable substance.

The invention relates to a flame retardant according to the preamble of claim 1 and to a process for reducing the risk of fire posed by an ignitable substance according to the preamble of claim 13.

DE 29 10 595 C2 discloses a flame-retardant composite molding using an intumescent composition. This intumescent composition is composed of a carbon-forming material, in particular of a sugar, of a catalyst, of a blowing agent and of a spherical filler. The intumescent composition forms, at temperatures above 180° C., a foam which for a certain time keeps the flame front away from the composite molding. However, a disadvantage of this intumescent composition is that at high temperatures above about 300° C. it itself burns, the result being that the flame-retardant action can be lost in fires which last for a long time or generate very high temperatures.

An object underlying the invention is to provide a flame retardant which provides dependable flame retardancy extending to very high fire temperatures, even in the event of damage to the surface of the ignitable substance.

The invention achieves this object by using the features of claim 1 and by using the steps of claim 13.

The flame retardant as claimed in claim 1 is in essence composed of two important components, namely of a carbon donor and of a phosphorus-containing acid. The action of this phosphorus-containing acid on the carbon donor is in essence catalytic and causes conversion of the carbon into a fullerene at the very high temperatures prevailing in the event of a fire. These fullerenes are exclusively composed of carbon, but are macromolecules, which are not inflammable even at very high temperatures. A fullerene layer therefore forms on the ignitable substance in the event of a fire and inhibits ignition of the substance which is intrinsically and per se ignitable. If the fullerene layer formed is locally destroyed, another fullerene layer forms under it. The ignitable substance thus protects itself in the event of a fire. Although in the event of a fire the surface of the ignitable substance is damaged, in particular discolored, spread of the fire over a large area is thus dependably prevented. This is of considerable importance in sectors where there is fire risk, examples being chemical plants, or in the vehicle sector, in particular in aircraft. It was hitherto not possible in these sectors to use ignitable substances, such as wood, paper or thermoplastics, since the result would have been excessive fire risk. The obvious answer was to use more expensive materials instead. By virtue of the inventive flame retardant, low-cost construction materials can be used even in the fire-risk sectors mentioned. A further application sector for the flame retardant is construction of prefabricated housing, where wood is the usual material used for load bearing elements. By virtue of the inventive flame retardant, fire risk is substantially reduced in structures of this type. A carbon donor which has proven successful is an alcohol. When this polyhydric alcohol is converted to fullerenes, the part played by the phosphoric acid is merely that of a catalyst, and water is eliminated here from the carbon donor. This water escapes in the form of steam into the ambient atmosphere and at the same time brings about a desired effect of cooling the ignitable substance.

Catalysts which have proven to be particularly good as claimed in claim 2 are phosphoric acid, phosphonic and phosphorous acid. These have a direct effect on the carbon donor, without undergoing any prior chemical conversion.

For achievement of maximum effectiveness of fullerene formation in the event of a fire, it is advantageous, as claimed in claim 3, if the phosphorus-containing acid comprises at least one amino group. With this, the phosphorus-containing acid can bind a relatively large number of acid radicals, the molecule nevertheless being relatively compact. There is a nitrogen atom binding the acid radicals, and if the phosphorus-containing acid dissociates in the event of a fire this leads to additional suffocation of the fire via removal of oxygen.

As claimed in claim 4, a phosphorus-containing acid which has proven successful is an aminodialkyl-phosphoric acid, an aminodialkylphosphonic acid, an aminodialkylphosphorous acid, an aminotrialkyl-phosphoric acid, an aminotrialkylphosphonic acid or an aminotrialkylphosphorous acid.

Aminodimethylphosphoric acid, aminodimethylphosphonic acid, aminodimethylphosphorous acid, aminotrimethyl-phosphoric acid, aminotrimethylphosphonic acid and aminotrimethylphosphorous acid have very high capability for converting the carbon donor into fullerenes and are therefore preferred as phosphorus-containing acid as claimed in claim 5.

If the carbon donor is composed of a polyhydric alcohol as claimed in claim 6, the result is particularly effective conversion of the carbon donor into a fullerene.

For further improvement in fullerene formation, it is advantageous as claimed in claim 7 if the carbon donor comprises an alkali metal compound. The function of the alkali metal in fullerene formation here is not yet explained, but it is assumed to be catalytic.

As claimed in claim 8, sodium has proven particularly effective as alkali metal.

In order to achieve the best possible fullerene formation, as claimed in claim 9, it is advantageous if the carbon donor comprises an alkane skeleton having at least five, preferably at least seven, carbon atoms. If shorter alkane chains are used, the fullerene-generating effect is weaker. In principle, no upper limit can be stated for the length of the carbon skeleton. However, extremely long carbon skeletons lead to high molecular weights, the result being that the carbon donor would be difficult to apply to the ignitable substance. These disadvantages are clearly apparent for carbon chains having more than fifteen carbon atoms.

One particularly advantageous carbon donor is found in claim 10. This has a carbon skeleton in which each carbon atom has a functional group selected from —OH and -alkali metal. By virtue of this measure, each carbon atom of the alkane skeleton has bonding to the alkali metal plus hydrogen or firstly to hydrogen and secondly to an OH group. During the catalytic reaction with the phosphoric acid, the hydrogen and the OH group are eliminated and form water, and the alkane chain thus remains and forms the desired fullerene. By virtue of the selection of functional groups at each carbon atom of the alkane skeleton an efficient chemical reaction takes place with elimination of water and, with this, ideal fullerene formation. This lowers the activation and energy for fullerene formation, the result being ideal protection of the ignitable substance by the flame retardant.

As claimed in claim 11, it is advantageous if the flame retardant also comprises ammonia, which in particular improves the solubility of the phosphorus compound and of the carbon donor in one another. This is important for achievement of ideal catalytic action of the phosphorus compound.

To permit maximum effectiveness of application of the flame retardant to the ignitable substance, it is advantageous, as claimed in claim 12, if the flame retardant is in aqueous solution. It can thus be very easily applied by spraying onto the ignitable substance. As an alternative, it is also possible to mix the flame retardant in aqueous form directly with the ignitable substance, as long as the flame retardant is in a liquid phase.

In the process as claimed in claim 13, a flame retardant is applied to an ignitable substance in order to reduce the risk of fire posed by this substance, and in the event of fire generates a fullerene layer on its surface. This fullerene layer has only very low flammability, and thus dependably protects the ignitable substance in the event of fire. If the fullerene layer is locally destroyed, the flame retardant forms a new fullerene layer under the destroyed layer, thus giving ideal protection of the ignitable substance. The fullerene layer is deposited in the form of a network on the surface of the body to be protected. The mesh width of the network here is not more than 2 μm, and no flame front can therefore then penetrate as far as the surface of the body to be protected. A very small amount of fullerene is thus adequate to protect the body. A consequence of this is in turn that a relatively small amount of flame retardant is sufficient to form effective protection.

As claimed in claim 14, for producing the fullerene layer it is advantageous to utilize a chemical reaction of a carbon donor with a phosphorus compound. This chemical reaction proceeds only at very high temperatures which arise in the event of fire.

In order to permit simple application of the flame retardant to the ignitable substance, it is advantageous as claimed in claim 15 if the flame retardant is applied by spraying in aqueous solution, emulsion or suspension onto the ignitable substance.

This is very simple and therefore inexpensive to achieve industrially, but nevertheless provides a high level of protective effect to the ignitable substance.

As an alternative, or in addition, the flame retardant can also, as claimed in claim 16, be incorporated into the ignitable substance, the result being very effective protection in the entire volume of the ignitable substance. This is particularly important in cases where the ignitable substance can fracture in the event of fire, thus producing new, otherwise unprotected, surfaces.

Claim 17 gives a simple method of achieving the above-mentioned process. In this, before the ignitable substance hardens, it is mixed in at least to some extent liquid form with the flame retardant. If the ignitable substance is a polymer, the flame retardant can be incorporated by mixing into the unpolymerized liquid with the monomers and the polymerization auxiliary. Once the polymerization reaction has concluded, the flame retardant protects the entire volume of the polymer.

It is also advantageous as claimed in claim 18 if the flame retardant is mixed with a binder. This can by way of example be a loam, adhesive or a synthetic resin which binds solid parts of the ignitable substance, e.g. rubber granules or sawdust, to give a solid matrix.

### EXAMPLES

A solution is composed of

| | |
|---|---|
| 35% of water, | H₂O |
| 10% of 80% strength phosphoric acid | 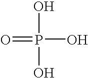 |
| 24% of 25% strength ammonia | NH₃ |
| and | |
| 31% of aminotrimethylphosphonic acid | 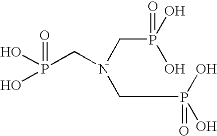 |

The quantitative data mentioned are percentages by weight. The solution also comprises, as carbon donor, an amount independent of the above quantitative data of sodium heptagluconate

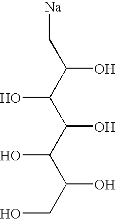

The solution is applied by spraying onto pressboard. After drying off the surface, the pressboard is not inflammable on exposure to direct flames using temperatures up to 1200° C.

The abovementioned formulation can be varied within wide limits. The amounts mixed of each of the abovementioned components can be from 1 to 50 parts. The flame retardant can also comprise wetting agents in order to achieve better wetting of surfaces, or thickeners, such as alkylamines.

The following reactions are initiated at very high temperatures in the event of a fire:

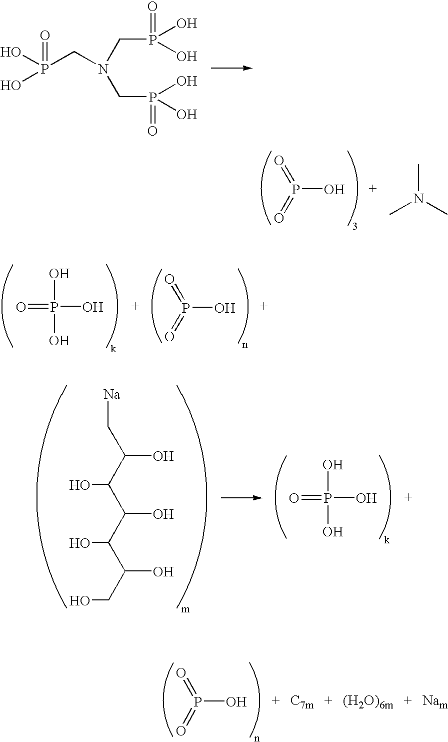

What is claimed is:

1. A flame retardant for reducing the risk of fire posed by an ignitable substance, where the flame retardant comprises at least one carbon donor and at least one phosphorus-containing acid, characterized in that the carbon donor comprises an alcohol.

2. The flame retardant as claimed in claim 1, characterized in that the phosphorus-containing acid comprises at least one phosphoric acid, phosphonic acid, or one phosphorous acid.

3. The flame retardant as claimed in claim 1 or 2, characterized in that the phosphorus-containing acid comprises at least one organic compound composed of at least one acid as claimed in claim 2 and comprises at least one amino group.

4. The flame retardant as claimed in claim 3, characterized in that the phosphorus-containing acid comprises at least one aminodi- and/or aminotrialkyl-phosphoric, -phosphonic and/or -phosphorous acid.

5. The flame retardant as claimed in claim 4, characterized in that the phosphorus-containing acid comprises at least one aminodi- and/or aminotrimethylphosphoric, -phosphonic and/or -phosphorous acid.

6. The flame retardant as claimed in at least one of claims 1 to 5, characterized in that the carbon donor comprises a preferably polyhydric alcohol.

7. The flame retardant as claimed in claim 6, characterized in that the carbon donor comprises an alkali metal compound.

8. The flame retardant as claimed in claim 7, characterized in that the alkali metal is sodium.

9. The flame retardant as claimed in at least one of claims 1 to 8, characterized in that the carbon donor comprises an alkane skeleton having at least five, preferably at least seven, carbon atoms.

10. The flame retardant as claimed in claim 9, characterized in that each carbon atom of the carbon donor comprises at least one functional group selected from —OH and -alkali metal.

11. The flame retardant as claimed in at least one of claims 1 to 10, characterized in that the flame retardant comprises ammonia.

12. The flame retardant as claimed in at least one of claims 1 to 11, characterized in that, prior to application to the ignitable substance, the flame retardant is present in aqueous solution, emulsion or suspension.

13. The process for reducing the risk of fire posed by an ignitable substance, characterized in that a flame retardant is applied to the ignitable substance and in the event of fire produces, on the surface of the ignitable substance, a fullerene layer in the form of a network whose mesh width is not more than 2 μm.

14. The process as claimed in claim 13, characterized in that the fullerene layer is produced via chemical reaction of a carbon donor with a phosphorus compound.

15. The process as claimed in claim 13 or 14, characterized in that the flame retardant is applied by spraying in aqueous solution, emulsion or suspension to the ignitable substance.

16. The process as claimed in at least one of claims 13 to 15, characterized in that the flame retardant is incorporated into the ignitable substance.

17. The process as claimed in claim 16, characterized in that, before the ignitable substance hardens, it is mixed in at least to some extent liquid form with the flame retardant.

18. The process as claimed in claim 17, characterized in that the flame retardant is mixed with a binder.
